(19) United States
(12) Patent Application Publication
(10) Pub. No.: US 2005/0248677 A1
(43) Pub. Date: Nov. 10, 2005

(54) Image pickup device

(76) Inventors: Yoshito Katagiri, Tokyo (JP); Takeshi Yasutomi, Tokyo (JP)

Correspondence Address: CANTOR COLBURN, LLP, 55 GRIFFIN ROAD SOUTH, BLOOMFIELD, CT, 06002, US

(21) Appl. No.: 11/122,179

(22) Filed: May 4, 2005

(30) Foreign Application Priority Data
May 10, 2004 (JP) JP2004-139494
May 10, 2004 (JP) JP2004-139495
May 10, 2004 (JP) JP2004-139496

(51) Int. Cl. H04N 9/64; H04N 5/228; H04N 5/222

(52) U.S. Cl. 348/333.02; 348/222.1

(57) ABSTRACT

An image pickup apparatus includes: an image pickup element for photoelectrically converting a light from an object; an image pickup optical system for introducing the light from the object into the image pickup element; an auxiliary light emitting device for emitting an auxiliary light to the object; a display device for displaying an image; and a shading estimation device for estimating an occurrence of a shading of the auxiliary light caused by a part of the image pickup optical system. The display device displays a state of the shading thereon on the basis of an estimated result by the shading estimation device.

This application claims priority from Japanese Patent Application No. 2004-139494 filed on May 10, 2004, No. 2000-139495 filed on May 10, and No. 2004-139496 filed on May 10, 2004, which are incorporated hereinto by reference.

### BACKGROUND OF THE INVENTION

The present invention relates to an image pickup device and more particularly to an image pickup device having an image pickup element, an auxiliary light emitting means, a display unit for displaying images, and a storage means for storing images.

Conventionally, an image pickup device represented by a camera has an auxiliary light emitting means such as an electric flash and facilitates photographing in the dark.

On the other hand, in photographing using the auxiliary light emitting means such as a flash, it is known that depending upon photographing conditions, by a lens tube containing an image pickup optical system projected from the image pickup device body, the auxiliary light beam is interrupted and the so-called shading occurs. It is known that the occurrence of shading is more remarkable particularly in short distance photographing when using a wide-angle lens.

For such a problem of shading at the time of flash photographing, various proposals have been made.

For this problem of shading, to miniaturize the image pickup device and reduce shading, an image pickup device for storing a flash along the periphery of the body frame and rotating it along the face almost perpendicular to the optical axis of the image pickup optical system so as to project from the frame is disclosed (for example, refer to Patent Document 1).

Further, a camera for obtaining the existence of shading by calculation from lens data obtained from a mounted photographing lens and data of a camera built-in flash which is written beforehand and when judging an occurrence of shading from the calculation result, prohibiting emission of light (for example, refer to Patent Document 2).

Patent Document 1 represents Japanese Patent Application 2003-330071, and Patent Document 2 represents Japanese Patent Application 2001-13559.

In recent years, the so-called digital camera having a display unit for using an image pickup element for photoelectrically converting object light in place of a camera using a film, performing a predetermined process for output from the image pickup element to obtain image data, storing the image data in a storage medium, and displaying the stored image has been used generally.

Such a digital camera can perform short distance photographing beyond comparison with a camera using a conventional film in correspondence with rapid miniaturization. Furthermore, when the image pickup optical system used is a zoom lens, a lens constitution that the total length is increased starting from the one when the angle is widened is adopted and in accordance with them, the aforementioned problem of shading is more apt to arise.

On the other hand, the image pickup device described in Patent Document 1 mentioned above, since the mechanism for rotating the flash emitting section must be installed on the camera body side, is not desirable for miniaturization. Further, the camera described in Patent Document 2 mentioned above prohibits flash emission, thereby causes a problem of not only reduction in the color reproduction but also camera shaking.

On the other hand, in the digital camera, a photographed image can be reproduced on the display unit and be confirmed immediately, so that even if a little bit of shading occurs, if the necessary part of an object is not shaded, a use method for trimming and using it after photographing is available and a reduction in the color reproduction and camera shaking may cause a big problem rather than a little bit of shading.

On the other hand, in the digital camera, even if a little bit of shading occurs, if the necessary part of an object is not shaded, a use method for trimming and using it after photographing is available, and photographed image data is outputted to a personal computer, and an image process such as trimming is performed, and an original image from which the shaded part is deleted can be prepared. However, if the device and operation are not well aware of, it is difficult to prepare an intended image.

### SUMMARY OF THE INVENTION

A first object of the present invention, with the foregoing in view, is to confirm before photographing the shading occurrence state when auxiliary light is used by a display unit and obtain an image pickup device capable of photographing in accordance with a photographing image of a user.

Furthermore, a second object of the present invention is to obtain an image pickup device for easily photographing and recording an image free of shading even by a user who is not well aware of devices such as the image pickup device and a personal computer and operations thereof.

The embodiments (1) to (3) for accomplishing the above objects are indicated below.

(1) An image pickup device comprising an image pickup element for photoelectrically converting object light, an image pickup optical system for leading the object light to the image pickup element, an auxiliary light emitting means for irradiating the auxiliary light to the object, and a display unit for displaying images is characterized in that the apparatus has a shading estimation means for estimating an occurrence of shading of the auxiliary light due to a part of the image pickup system, which displays the shading state on the display unit on the basis of estimated results of the shading estimation means.

(2) An image pickup device comprising an image pickup element for photoelectrically converting object light, an image pickup optical system for leading the object light to the image pickup element, an auxiliary light emitting means for irradiating the auxiliary light to the object, and a display unit for displaying images is characterized in that the apparatus has a shading detection means for detecting an occurrence of shading of the auxiliary light due to a part of the image pickup system and when shading is detected by the detection means, it displays an image in which the shading is detected on the display unit.

(3) An image pickup device comprising an image pickup element for photoelectrically converting object light, an image pickup optical system for leading the object light to the image pickup element, and an auxiliary light emitting means for irradiating the auxiliary light to the object is characterized in that when an image in which shading of the auxiliary light due to a part of the image pickup system occurs is obtained, a predetermined process is performed for the image.

### BRIEF DESCRIPTION OF THE DRAWINGS

FIGS. 1(a) and 1(b) are drawings showing the structure of a digital camera which is an example of the image pickup device relating to the present invention.

FIG. 2 is a schematic block diagram showing the internal constitution of the digital camera shown in FIGS. 1(a) and 1(b).

FIG. 3 is a flow chart showing the schematic operation in the photographing mode of a digital camera which is an example of the image pickup device relating to the present invention.

FIG. 4 is drawing showing a focus evaluation area for evaluating object image data during the AF function operation of the camera of the present invention.

FIG. 5 is an example of a graph which is the origin of a table prepared beforehand for judging whether it is inside the shading occurrence area or not.

FIGS. 6(a) to 6(c) are drawings showing an example of a shading occurrence warning superimposed on a preview image.

FIG. 7 is a flow chart showing the schematic operation in the photographing mode of a digital camera which is an example of the image pickup device relating to the present invention.

FIG. 8 is an example of a graph which is the origin of a table prepared beforehand to be used for judging whether the object distance is within a predetermined range or not.

FIGS. 9(a) and 9(b) are drawings showing an example of areas for comparing an image fetched by pre-emission of light.

FIG. 10 is a display example of an image when an occurrence of shading is detected by a shading detection means.

FIG. 11 is a flow chart showing an example of another schematic operation in the photographing mode of a digital camera which is an example of the image pickup device relating to the present invention.

FIGS. 12(a) and 12(b) are schematic views showing fetched images.

FIG. 13 is a flow chart showing the schematic operation in the photographing mode of a digital camera which is an example of the image pickup device relating to the present invention.

FIGS. 14(a) and 14(b) are schematic views showing a fetched image.

FIGS. 15(a) and 15(b) are schematic views when the part where no shading occurs is trimmed from the photographed image.

FIG. 16 is a flow chart showing an example of still another schematic operation in the photographing mode of a digital camera which is an example of the image pickup device relating to the present invention.

FIGS. 17(a) to 17(e) are conceptual diagrams showing an example of image composition.

### DETAILED DESCRIPTION OF THE PREFERRED EMBODIMENT

The further preferred embodiments (4) to (15) for accomplishing the above objects are indicated below.

(4) The shading estimation means is the image pickup device described in (1) for estimating shading on the basis of the distance of an object in the neighborhood of the position on the photographing screen where shading occurs.

(5) The shading state is displayed by the image pickup device described in (1) or (4) for superimposing it on a preview image to display.

(6) The image pickup device has a storage means for recording photographed image data and a release means for discriminating the semi-press state and the full-press state and it is any of the image pickup devices described in (1), (4), and (5) for displaying the shading state in the semi-press state of the release means, photographing in the full-press state of the release means, and storing image data obtained by photographing using the auxiliary light emitting means in the storage means.

Namely, the inventor found that in consideration of the characteristic of no one but the image pickup device capable of displaying an image obtained by the image pickup element before photographing in real time, the estimated shading occurrence state when auxiliary light is used is displayed on the display unit, thus a user can straight continue photographing, change the setting so as to prevent an occurrence of shading, and photograph according to his photographing image and developed the present invention. (This may be referred to as “a shading estimation mode”.)

(7) The shading detection means is the image pickup device described in (2) for obtaining an image using the auxiliary light emitting means under the photographing condition using the auxiliary light emitting means and detecting shading of light projection of the auxiliary light emitting means on the basis of the brightness at a predetermined position of the aforementioned image.

(8) The shading detection means is the image pickup device described in (2) for obtaining a first image using the auxiliary light emitting means for an object, obtaining a second image using no auxiliary light emitting means, comparing the first image with the second image, and on the basis of comparison results, detecting shading of light projection of the auxiliary light emitting means.

(9) Obtaining of the first image and obtaining of the second image are performed by the image pickup device described in (8) under the photographing condition using the auxiliary light emitting means.

(10) The aforementioned comparison is made by the image pickup device described in (8) or (9) for comparing the first image and second image in predetermined areas thereof.

(11) The image pickup device has a storage means for recording photographed image data and a release means for discriminating the semi-press state and the full-press state and it is any of the image pickup devices described in (2) and (7) to (10) for operating the detection means in the semi-press state of the release means, photographing in the full-press state of the release means, and storing image data obtained by photographing using the auxiliary light emitting means in the storage means.

Namely, the inventor found that in consideration of the characteristic of no one but the image pickup device capable of displaying an image obtained by the image pickup element before photographing in real time, an occurrence of shading when the auxiliary light is used before photographing, and the detected shading occurrence state is displayed on the display unit, thus a user can straight continue photographing, change the setting so as to prevent an occurrence of shading, and photograph according to his photographing image and developed the present invention. (This may be referred to as “a shading warning mode”.)

(12) The image pickup device is the image pickup device described in (3) having a shading detection means for detecting an occurrence of shading of the auxiliary light for performing the aforementioned process when the shading detection means detects an occurrence of shading.

(13) The process is a process of trimming the image of the part where no shading occurs performed by the image pickup device described in (3) or (12).

(14) The process is a composition process of an image obtained using the auxiliary light and an image obtained using no auxiliary light performed by the image pickup device described in (3) or (12). (This may be referred to as “an image composition mode”.)

(15) The image pickup device is any of the image pickup devices described in (3) and (12) to (14) having a storage means for recording a photographed image for performing a predetermined process for the image and then recording it in the storage means.

Hereinafter, the present invention will be explained in detail with reference to the embodiments, though the present invention is not limited to them.

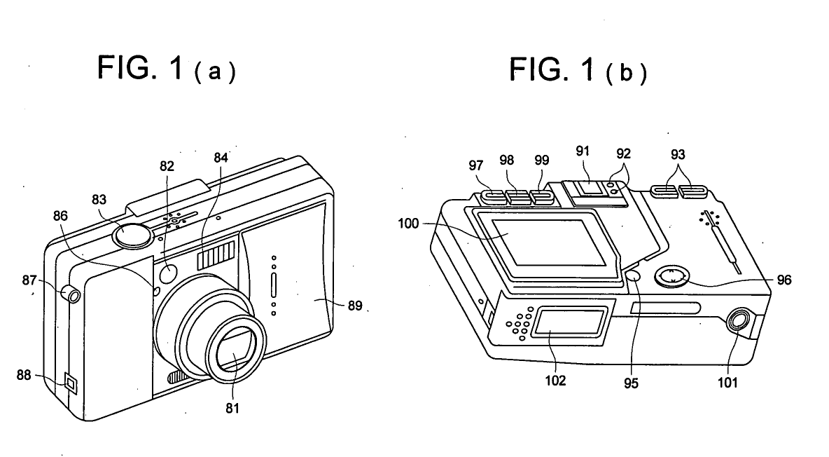

FIGS. 1(a) and 1(b) are drawings showing the structure of a digital camera which is an example of the image pickup device relating to the present invention. FIG. 1(a) is a perspective view of the front of the camera and FIG. 1(b) is a perspective view of the rear of the camera.

In FIG. 1(a), numeral 81 indicates a zoom image pickup optical system, 82 a finder window, 83 a release button, 84 a flash light emitting section, 86 a light adjusting sensor window, 87 a strap attaching section, and 88 an external input and output terminal (for example, a USB terminal). Numeral 89 indicates a lens cover and when the camera is not in use, the zoom image pickup optical system 81 is submerged in the main body of the camera.

With respect to the release button 83, by the first stage of depressing or the half depression (hereinafter, referred to as turning ON the switch S1), the image pickup operation of the camera, that is, the focusing operation or the photometry operation is performed and by the second stage of depressing or the full depression (hereinafter, referred to as turning ON the switch S2), the image pickup exposure operation is performed.

In FIG. 1(b), numeral 91 indicates a finder eyepieace section and 92 indicates red and green display lamps for displaying information of AF or AE to a photographer by lighting or blinking. Numeral 93 indicates zoom buttons for performing zoom-up or zoom-down. Numeral 95 indicates a menu and set button, 96 a selection button composed of a four-way switch, and 100 an image display section for displaying an image or character information. The camera has a function for displaying various menus on the image display section 100 by the menu and set button 95, selecting one of them by the selection button 96, and deciding it by the menu and set button 95. Numeral 97 indicates a reproduction button for reproducing a photographed image. Numeral 98 indicates a display button for selecting display or erasure of an image and character information displayed on the image display section 100. Numeral 101 indicates a tripod hole and 102 indicates a batterry and card cover. Inside the batterry and card cover 102, a battery for supplying power of the camera and a card slot for recording a photographed image are installed and a card type recording memory for recording images is removably installed.

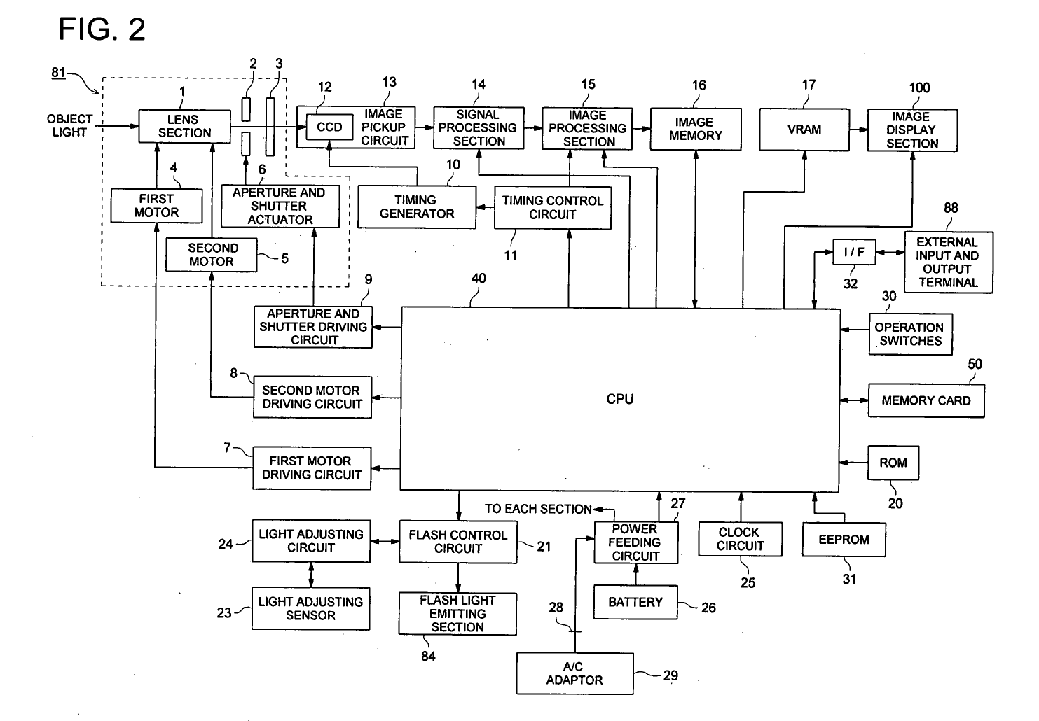

FIG. 2 is a schematic block diagram showing the internal constitution of the digital camera shown in FIG. 1. The internal constitution will be explained by referring to FIG. 2. Further, in the present invention, as an image pickup element, a CCD (charge coupled device) type image sensor and a CMOS (complementary metal-oxide semiconductor) type image sensor can be applied. However, in this embodiment, a camera using the CCD type image sensor as an image pickup element will be explained.

In the drawing, numeral 40 indicates a CPU for controlling the circuits. The zoom image pickup optical system 81 is composed of a lens section 1, an aperture and shutter unit 2, an optical filter 3 composed of an infrared cut filter and an optical low-pass filter which are laminated, a first motor 4, a second motor 5, and an aperture and shutter actuator 6.

The lens section 1, more in detail, is formed as a lens system having a plurality of lenses and the position on the optical axis of these plurality of lenses is moved by driving the first motor 4 to change the power thereof. Further, among these plurality of lenses, the lens used for focusing is driven by the second motor 5 to adjust the focus. Furthermore, the aperture and shutter unit is opened or closed by the aperture and shutter actuator 6 to adjust the exposure amount. The first motor 4, second motor 5, and aperture and shutter actuator 6 are driven via a first motor driving circuit 7, a second motor driving circuit 8, and an aperture and shutter driving circuit 9 which are respectively controlled by a control signal from the CPU 40.

A timing generator 10 generates a drive control signal of a CCD 12 on the basis of a clock sent from a timing control circuit 11 and generates and outputs clock signals such as timing signals of charge storage start and end of the CCD 12 or reading control signals of the charge stored amount of each pixel (a horizontal synchronous signal, a vertical synchronous signal, a transfer signal) to the CCD 12. An image pickup circuit 13 outputs image analog signals of the color components of R (red), G (green), and B (blue) to a signal processing section 14 when object light is photoelectrically converted by the CCD 12 and the CCD uses, for example, a color primary filter.

The signal processing section 14 performs a signal process for the image analog signals outputted from the image pickup circuit 13. The signal processing section 14 performs noise reduction and gain adjustment of the image analog signals by correlative double sampling (CDS) and auto gain control (AGC) and outputs them to an image processing section 15.

The image processing section 15, on the basis of an A-D conversion clock from the timing control circuit 11, A-D converts the inputted image analog signals to digital signals (hereinafter, referred to as pixel data). Next, the image processing section 15 performs a black level correction of the pixel data and then performs a white balance (WB) adjustment. The white balance adjustment is performed by a conversion factor inputted from the CPU 40. The conversion factor is set every a photographed image. Furthermore, the image processing section performs the y correction, and then outputs the pixel data to an image memory 16. The image memory 16 is a memory for storing the pixel data outputted from the image processing section 15.

A VRAM 17 is a backup memory of images displayed on the image display section 100 and has at least a storage capacity of an integrated value of the number of pixels of the image display section 100 and the number of bits necessary for display or more. For the image display section 100, a display unit such an LCD or an organic EL is used. Further, according to a display unit used, between the VRAM 17 and the image display section 100, a D-A conversion section for converting pixel data from digital to analog is installed.

By doing this, at the time of framing during photographing, pixel data picked up at a predetermined time interval is stored in the image memory 16, is subject to a predetermined signal process by the CPU 40, then is transferred to the VRAM 17, and is displayed on the image display section 100, thus the object image can be confirmed, and it can be used as a finder (referred to as preview image display).

A photographed image recorded in a removable image recording memory card 50 is transferred to the CPU 40 via the interface corresponding to a card in the CPU, is subject to a predetermined signal process by the CPU 40, then is transferred to the VRAM 17, is displayed on the image display section 100, and can be reproduced.

An interface 32 sends or receives a signal to or from an external personal computer or printer, and via the external input and output terminal (for example, a USB terminal) 88, sends a signal to the external personal computer or printer or receives data from the external personal computer or printer.

A flash control circuit 21 is a circuit for controlling light emission of a flash light emitting section 84. The flash control circuit 21 is controlled by the CPU 40, controls use of flash light emission, the light emission timing, and charging of a light emission capacitor, and on the basis of a light emission stop signal inputted from a light adjusting circuit 24 connected to a light adjusting sensor 23, stops the light emission.

A clock circuit 25 controls the photographing date and time, and although it may receive power from a power feeding circuit 27 for feeding power to each unit to operate, it is desirably operated by a separate power source not drawn.

Feeding power to the CPU 40 and the respective units is performed by the power feeding circuit 27. To the power feeding circuit 27, power is supplied from an A/C adaptor 29 via a battery 26 or a DC input terminal 28.

An operation switch 30 is a switch group for turning the units ON or OFF by various operation buttons such as the release button 83, the zoom button 93, and the menu and set button 95 shown in FIG. 1. An ON or OFF signal of the operation switch group 30 is sent to the CPU 40 and the CPU 40 controls the operation of each unit according to the operation switch turned ON.

An EEPROM 31 is a non-volatile memory, which is used to store individual different characteristic values of the camera. The individual different characteristic values are, for example, information of the infinite position of the focusing lens at each focal distance of the zoom image pickup optical system 81 and are written in the manufacture process. The individual different characteristic values of the camera are read by the CPU 40 from the EEPROM 31 when necessary and are used for controlling each unit.

Further, the CPU 40, on the basis of the software stored in a ROM 20, not only sends and receives data and controls the timing of each unit but also performs various functions. For example, the CPU 40 has an AE function for determining the exposure conditions of an aperture value and a shutter speed during photographing on the basis of pixel data obtained by the image memory 16, an AF function for moving the focusing lens little by little, generating image data from pixel data obtained respectively, evaluating on the basis of this image data, and determining an optimal focusing lens position, a function for generating and compressing image data from the pixel data in order to record it in the memory card 50, and a function for reading and expanding the image data recorded in the memory card 50 in order to display the images recorded in the memory car 50 on the image display section 100.

The aforementioned is the internal block constitution of the digital camera which is an example of the image pickup device relating to the present invention.

Further, the digital camera which is an example of the image pickup device of the present invention has a photographing mode for photographing a still image and/or a moving image, a reproduction mode for reproducing or deleting the photographed image, and a set-up mode for setting various functions of the camera. The present invention relates to the photographing mode, so that the photographing mode will be explained below in detail.

### First Embodiment

Hereinafter, the first embodiment of the present invention will be explained.

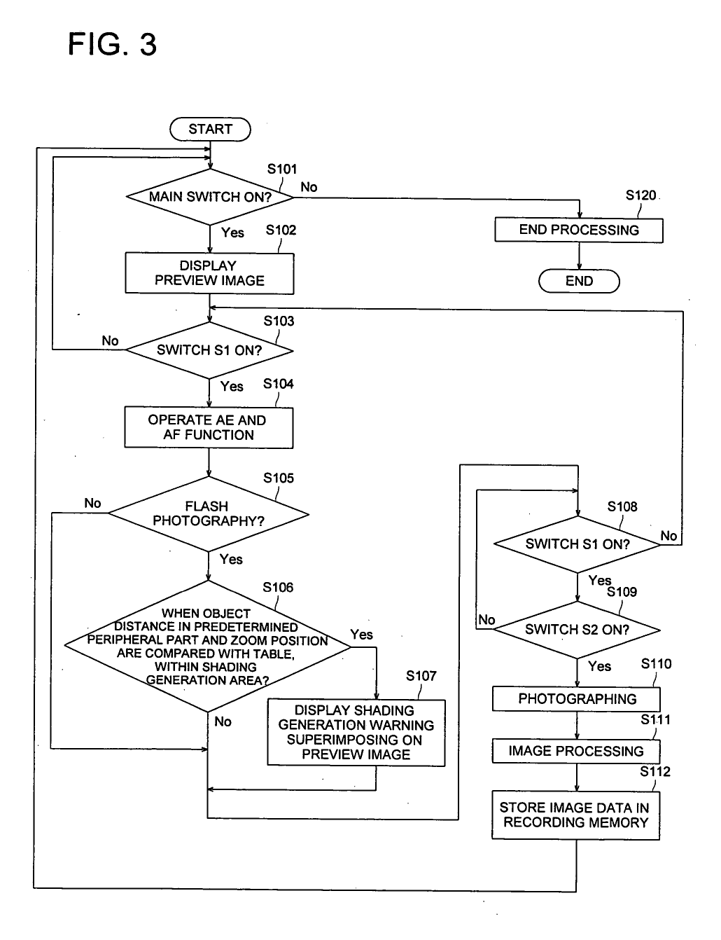

FIG. 3 is a flow chart showing the schematic operation in the photographing mode of the digital camera which is an example of the image pickup device relating to the present invention. Further, the operations indicated below, on the basis of the software and constant which are stored in the ROM 20 and EEPROM 31 shown in FIG. 2, are performed by the CPU 40 controlling each unit. Hereinafter, the operations will be explained by referring to FIG. 3.

In the drawing, firstly, the CPU 40 judges whether the main switch is turned ON or not (Step S101). When the main switch is turned ON (Yes at Step S101), the CPU 40 displays a preview image (Step S102). The preview image, as mentioned above, is displayed on the image display section 100 (refer to FIG. 2).

Hereafter, the CPU 40 waits for the switch S1 to be turned ON (Step S103). When the switch S1 is not turned ON (No at Step S103), the process enters the loop of S101 to S103 and unless the main switch is turned OFF at Step S101, the preview image is displayed continuously.

When the switch S1 is turned ON (Yes at Step S103), the CPU 40 performs the operations of the AE and AF functions (Step S104). The operations of the AE and AF functions, as mentioned above, determine the exposure conditions of an aperture value and a shutter speed during photographing and necessity of flash light emission and determine an optimal focusing lens position by moving the focusing lens little by little, generating image data from pixel data obtained respectively, and evaluating on the basis of this image data.

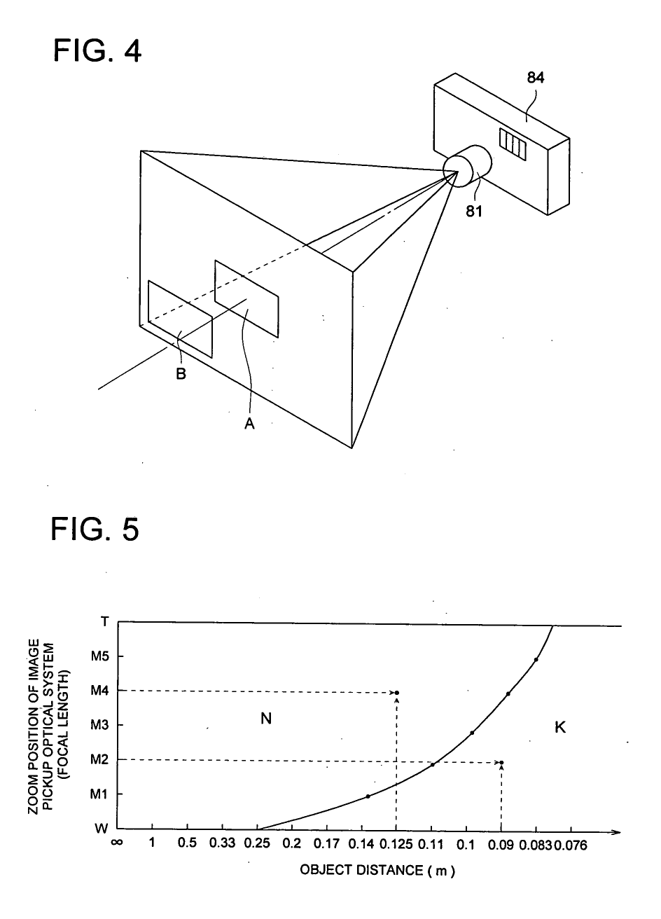

FIG. 4 is drawing showing a focus evaluation area for evaluating object image data during the AF function operation of the camera of the present invention. The drawing shows a case that viewed from the front of the camera, the flash light emitting section 84 which is an auxiliary light emitting means is arranged on the upper right of the image pickup optical system 81.

As shown in FIG. 4, when the flash light emitting section 84 is arranged on the upper right of the image pickup optical system 81 viewed from the front of the camera, in the area, indicated by A, around the optical axis on the object side and the area, indicated by B, of the peripheral part on the opposite angle side of the position of the flash light emitting section across the image pickup optical system 81, the object image data is evaluated, and the respective best focusing lens positions are determined. By doing this, the object distances in the respective areas of the central part A and peripheral part B are found.

The best focusing lens position in the area of the central part A is used as a focusing lens stop position during photographing and the best focusing lens position in the area of the peripheral part B is converted to an object distance and is used in the subsequent flow shown in FIG. 3.

Again in FIG. 3, after the operations of the AE and AF functions are finished, the CPU 40 judges whether flash photographing is to be performed or not (Step S105). The judgment is carried out from the AE function operation performed at Step S104 and flash mode setting results. When emission of a flash which is auxiliary light is necessary (Yes at Step S105), the CPU 40 checks the object distance on the peripheral part and the zoom position of the photographing lens with the table prepared beforehand and judges whether they are in the shading occurrence area or not (Step S106).

FIG. 5 is an example of a graph which is the origin of a table prepared beforehand for judging whether it is inside the shading occurrence area or not. In the drawing, the axis of abscissa indicates the object distance, and the axis of ordinate indicates the zoom position of the image pickup optical system, and the area K where shading occurs and the area N where no shading occurs are shown, and they are tabulated and stored, for example, in the EEPROM 31 of the camera (refer to FIG. 2). The table may be prepared on the basis of a geometric figure from the camera layout or may be prepared from actually photographed data. On the basis of the table, before photographing, the CPU 40 estimates whether shading occurs or not. Further, in the drawing, a symbol W indicates a wide edge, T a tele edge, and M1 to M5 an intermediate focal length.

In the graph shown in FIG. 5, that is, in the table, for example, when the zoom position of the image pickup optical system is M2 and the object distance in the peripheral part B is 0.09 m, the combination of the two exists in the area K, so that shading is estimated to occur. Further, when the zoom position of the image pickup optical system is M4 and the object distance in the peripheral part B is 0.125 m, the combination of the two exists in the area N, so that shading is estimated not to occur. Namely, the table is equivalent to the shading estimation means and estimates and judges the existence of an occurrence of shading.

Again in FIG. 3, at Step S106, when the combination of the zoom position of the image pickup optical system and the object distance in the peripheral part B is judged to be in the shading occurrence area from the aforementioned table which is the shading estimation means (Yes at Step S106), the CPU 40 (refer to FIG. 2) displays a shading occurrence warning superimposed on a preview image (Step S107).

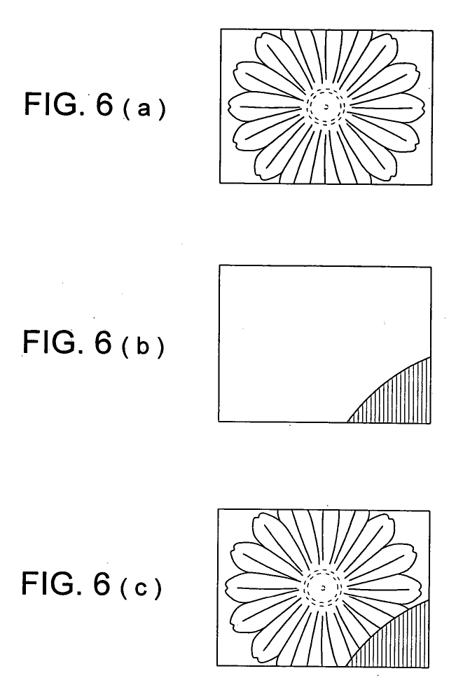

FIG. 6 is drawings showing an example of a shading occurrence warning superimposed on a preview image. FIG. 6(a) shows a preview image, and FIG. 6(b) shows an image of the shaded part stored in the EEPROM 31 beforehand, and FIG. 6(c) shows a display image in which the image of the shaded part is superimposed on the preview image.

As shown in the drawing, the preview image uses no auxiliary light, so that as shown in FIG. 6(a), an image where no shading occurs is shown. The pre-stored image of the shaded part shown in FIG. 6(b) is fit, composed, and superimposed on the concerned image and a photographed image after use of auxiliary light as shown in FIG. 6(c) is estimated and displayed on the image display apparatus to give a shading occurrence warning to a user. The shading amount in this display is preferably structured so as to vary with a combination of the zoom position with the object distance and a display image approached to a photographed image after use of auxiliary light may be obtained.

Further, at this time, a preview image to be used more preferably uses the preview image fetched after ending of the AF operation.

Further, needless to say, the shape of the shaded part stored in the EEPROM shown in FIG. 6(b) can be changed properly according to the camera layout of the flash light emitting section 84 and the image pickup optical system 81, and the shape may be prepared on the basis of a geometrical figure from the camera layout or may be prepared from actually photographed data.

Again in FIG. 3, at Step S107, the CPU 40 superimposes and displays the shading occurrence warning on the preview image and then judges again whether the switch S1 is turned ON or not (Step S108). When the switch S1 is turned OFF (No at Step S108), the CPU 40 clears the aforementioned shading occurrence warning superimposed on the preview image, the exposure conditions stored by the AE and AF operations, and the data of the best focusing lens position and returns to Step S103.

When the switch S1 is kept ON continuously (Yes at Step S108), the CPU 40 waits for the switch S2 to be turned ON (Step S109). When the switch S2 is turned ON (Yes at Step S109), the CPU 40 performs the photographing process (Step S110). The photographing process is performed at the focus lens position determined at Step S104 and under the exposure conditions and the photographed image is fetched. Hereafter, the photographed pixel data is subject to the image process (Step S111) and the obtained image data is stored in the memory card which is a recording memory (Step S112). Then, the photographing of one sheet of image is finished and the process is returned to Step S101.

Further, at Step S105, when the emission of flash light which is auxiliary light is judged to be unnecessary (No at Step S105), the CPU 40 does not perform the operations at Steps S106 and S107, moves to Step S108, and similarly performs the operations at Steps S108 to S112.

On the other hand, at Step S101, when the main switch is turned OFF (No at Step S101), the CPU 40 performs the end operation of each unit such as submerging of the image pickup optical system (Step S120) and then finishes the process.

As explained above, the image pickup device has the shading estimation means for estimating an occurrence of shading of the auxiliary light and on the basis of estimation results of the shading estimation means, displays the shading state on the display unit, thereby can confirm the shading occurrence state before photographing. Therefore, when the device can respond to it by trimming depending on the judgment of a user, he can continue straight the photographing or he changes the zoom position and the object distance in the peripheral part so as to prevent an occurrence of shading, sets the same photographing power, and then can photograph the object, thereby can obtain an image pickup device capable of photographing in accordance with his photographing image.

Further, the object distance in the neighborhood of the shading occurring position on the photographing screen is measured, and shading is estimated on the basis of the object distance, thus a more precise estimation of the shading state can be made.

Furthermore, when the shading state is superimposed and displayed on the preview image, photographing results can be estimated and the user can easily judge whether to continue straight photographing or to set again so as to prevent an occurrence of shading.

Further, in the above explanation, viewed from the front of the camera, the flash light emitting section 84 which is an auxiliary light emitting means is arranged on the upper right of the image pickup optical system 81. However, for example, when the flash light emitting section 84 is arranged right above the image pickup optical system 81 viewed from the front of the camera, the device may be structured so as to determine the area around the optical axis on the object side and the area under the position of the flash light emitting section across the image pickup optical system 81 as an area in the peripheral part and set the respective best focusing lens positions. Namely, the best focusing lens positions can be determined properly according to the layout of the flash light emitting section 84 and the image pickup optical system 81.

Further, the device is structured so as to estimate an occurrence of shading by the table prepared beforehand. However, the present invention is not limited to it and needless to say, a constitution of estimating by calculation is available.

According to the embodiment described in (1), on the basis of estimation results by the shading estimation means, the shading state is displayed on the display unit, so that the shading occurrence state can be confirmed before photographing. Therefore, when the device can respond to it by trimming depending on the judgment of a user, he can continue straight the photographing or he changes the zoom position and the object distance in the peripheral part so as to prevent an occurrence of shading, sets the same photographing power, and then can photograph the object, thereby can obtain an image pickup device capable of photographing in accordance with his photographing image.

According to (4) mentioned above, a more precise estimation of the shading state can be made.

According to (5) mentioned above, photographing results can be estimated and the user can easily judge whether to continue straight photographing or to set again so as to prevent an occurrence of shading.

According to (6) mentioned above, the user can confirm the shading occurrence state by the display unit before photographing and can obtain an image pickup device capable of photographing in accordance with his photographing image.

### Second Embodiment

Hereinafter, the second embodiment of the present invention will be explained.

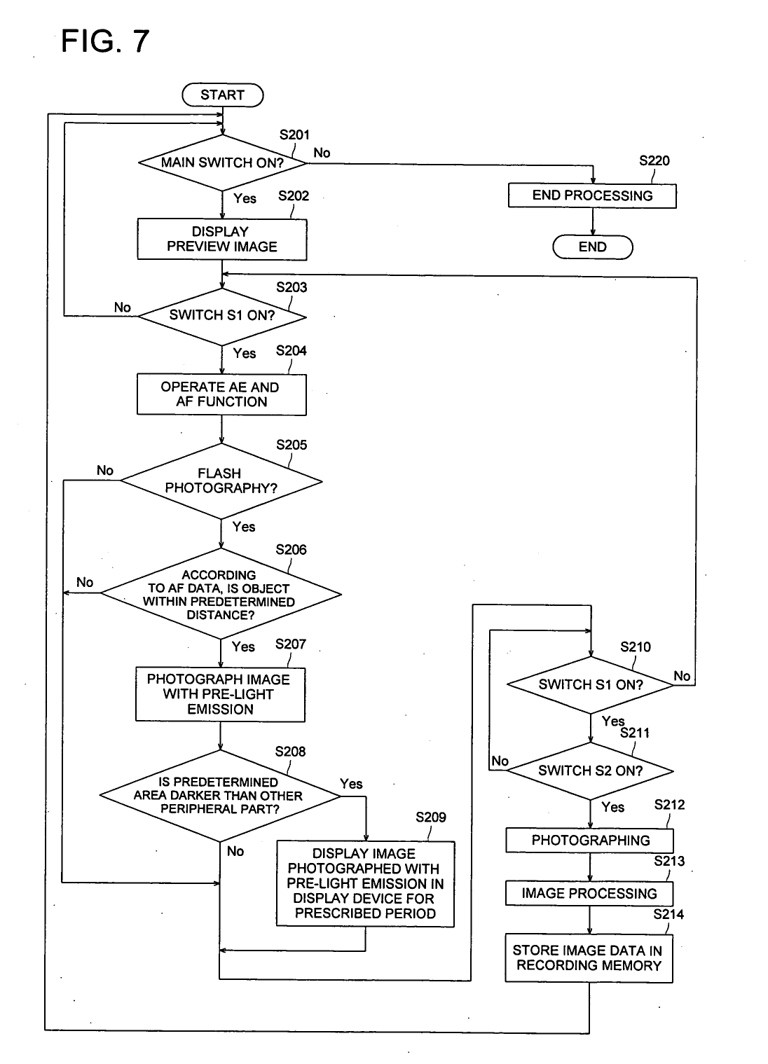

FIG. 7 is a flow chart showing the schematic operation in the photographing mode of a digital camera which is an example of the image pickup device relating to the present invention. Further, the operations indicated below, on the basis of the software and constant which are stored in the ROM 20 and EEPROM 31 shown in FIG. 2, are performed by the CPU 40 controlling each unit. Hereinafter, the operations will be explained by referring to FIG. 7.

In the drawing, firstly, the CPU 40 judges whether the main switch is turned ON or not (Step S201). When the main switch is turned ON (Yes at Step S201), the CPU 40 displays a preview image (Step S202). The preview image, as mentioned above, is displayed on the image display section 100 (refer to FIG. 2).

Hereafter, the CPU 40 waits for the switch S1 to be turned ON (Step S203). When the switch S1 is not turned ON (No at Step S203), the process enters the loop of S201 to S203 and unless the main switch is turned OFF at Step S201, the preview image is displayed continuously.

When the switch S1 is turned ON (Yes at Step S203), the CPU 40 performs the operations of the AE and AF functions (Step S204). The operations of the AE and AF functions, as mentioned above, determine the exposure conditions of an aperture value and a shutter speed during photographing and necessity of flash light emission and determine an optimal focusing lens position by moving the focusing lens little by little, generating image data from pixel data obtained respectively, and evaluating on the basis of this image data.

After the operations of the AE and AF functions are finished, the CPU 40 judges whether photographing using a flash which is auxiliary light is to be performed or not, that is, whether a low brightness mode requiring flash light emission is to be used or a mode for forcibly emitting a flash is to be used (Step S205). The judgment is carried out from the AE function operation performed at Step S204 and flash mode setting results. When emission of a flash which is auxiliary light is necessary (Yes at Step S205), the CPU 40 judges from the AF function operation performed at Step S204 whether the object is within a predetermined distance or not (Step S206). When the object distance is judged to be shorter than the predetermined distance (Yes at Step S206), the CPU 40 pre-emits the flash light emitting section which is an auxiliary light emitting means and fetches the image at this time (Step S207). This pre-emission of light may be emission of light at a small guide number because the object distance is short. Further, the predetermined distance is preferably set to a distance at which shading is estimated to start to occur due to the layout and shape of the camera.

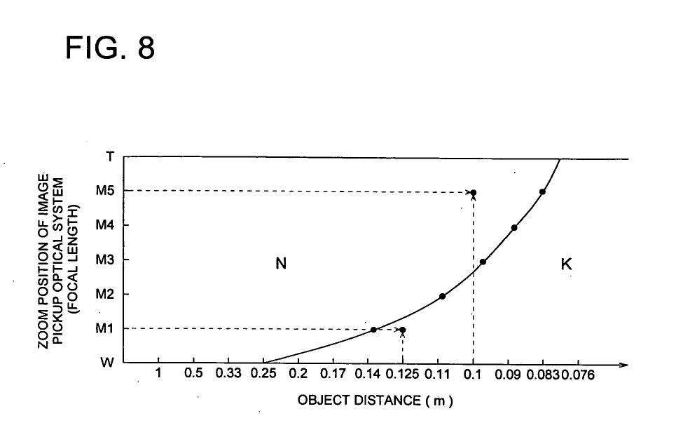

FIG. 8 is an example of a graph which is the origin of a table prepared beforehand to be used for judging whether the object distance is within a predetermined range or not. In the drawing, the axis of abscissa indicates the object distance, and the axis of ordinate indicates the zoom position of the image pickup optical system, and the object distance area K to be pre-emitted and the area N not to be pre-emitted are shown, and they are tabulated and stored, for example, in the EEPROM 31 of the camera (refer to FIG. 2). The table may be prepared on the basis of a geometric figure from the camera layout or may be prepared from actually photographed data. On the basis of the table, the CPU 40 judges whether to pre-emit or not. Further, in the drawing, a symbol W indicates a wide-end, T a tele-end, and M1 to M5 an intermediate focal length.

In the graph shown in FIG. 8, that is, in the table, for example, when the zoom position of the image pickup optical system is M1 and the object distance is 0.125 m, the combination of the two exists in the area K, so that light is pre-emitted and the image at this time is fetched. On the other hand, for example, when the zoom position of the image pickup optical system is M5 and the object distance is 0.1 m, the combination of the two exists in the area N, so that the CPU 40 judges that light is not pre-emitted. Namely, obtaining of an image by pre-emission of light is performed at the time of short distance photographing when flash light emission is a photographing condition. By doing this, useless power consumption can be prevented.

Again in FIG. 7, the CPU 40 (refer to FIG. 2) evaluates the pre-emitted and obtained image and judges whether a predetermined area of the image is darker than the circumference or not (Step S208). The predetermined area is determined as an area where an occurrence of shading is estimated due to the layout and shape of the camera among the peripheral part of the image and for comparison, the other peripheral part of the image is used. For example, in the camera shown in FIG. 1, an occurrence of shading on the lower right of the image is estimated and the lower right area and the lower left area where no shading occurs are compared. Further, the comparison area may vary with the object distance and focal length. Further, when the predetermined area is lower, for example, by 1.5 EV or more in voltage than the other area of the peripheral part of the image to be compared, the predetermined area is judged to be darker.

Namely, this embodiment compares a predetermined area of an image obtained by pre-emission of light, when the predetermined area is darker by a difference of a predetermined value or larger, judges that shading occurs, thereby can detect the existence of an occurrence of shading of the auxiliary light and such a means is referred to as a shading occurrence detection means.

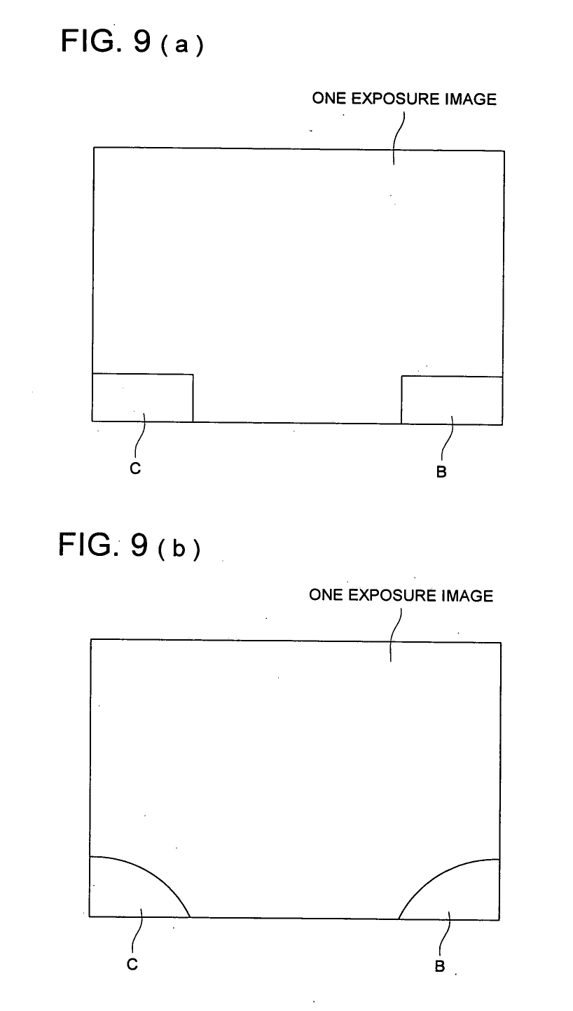

FIGS. 9(a) and 9(b) are drawings showing an example of areas for comparing an image obtained by pre-emission of light. The drawings, as the camera shown in FIG. 1, show the areas to be compared when the flash light emitting section is arranged on the upper right of the image pickup optical system viewed from the front of the camera.

As shown in FIGS. 9(a) and 9(b), the area B on the lower right of the image and the area C on the lower left are compared. The shape of the areas B and C may be a rectangle as shown in FIG. 9(a), a circular arc as shown in FIG. 9(b), or a line. Further, when using average brightness calculated for comparison, the area B may be compared with another area. Further, the areas are set properly according to the layout of the camera.

Again in FIG. 7, at Step S208, when the predetermined area of the image fetched by pre-emission of light is darker than the circumference (Yes at Step S208), the CPU 40 displays the image fetched by pre-emission of light on the display unit 100 (refer to FIG. 2) for a predetermined time, for example, for about 3 to 5 seconds (Step S209). Namely, when an occurrence of shading is detected by the shading detection means, the CPU 40 displays the image on the display unit for warning.

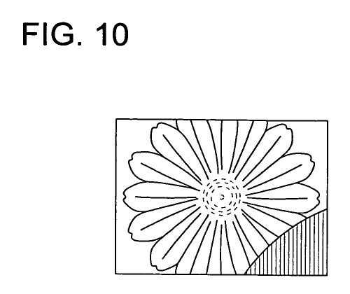

FIG. 10 is a display example of an image when an occurrence of shading is detected by the shading detection means. A shaded image obtained by pre-emission of light as shown in the drawing is displayed.

Again in FIG. 7, the CPU 40 judges again whether the switch S1 is turned ON or not (Step S210). When the switch S1 is turned OFF (No at Step S210), the CPU 40 clears the exposure conditions stored by the AE and AF operations and the data of the best focusing lens position and returns to Step S203.

When the switch S1 is kept ON continuously (Yes at Step S210), the CPU 40 waits for the switch S2 to be turned ON (Step S211). When the switch S2 is turned ON (Yes at Step S211), the CPU 40 performs the photographing process (Step S212). The photographing process is performed at the focus lens position determined at Step S204 and under the exposure conditions and the photographed image is fetched. Hereafter, the photographed pixel data is subject to the image process (Step S213) and the obtained image data is stored in the memory card which is a recording memory (Step S214). Then, the photographing of one sheet of image is finished and the process is returned to Step S201.

Further, when it is judged at Step S205 that no flash light emission photographing is performed (No at Step S205) and when it is judged at Step S206 that the object distance is larger than a predetermined value (No at Step S206), the process jumps to Step S210. Further, at Step S208, even when a predetermined area is higher in brightness than the area to be compared in the other peripheral part of the image or is smaller than, for example, a difference of 1.5 EV, the CPU 40 moves to Step S210 and performs the operations at Steps S210 to S214.

On the other hand, at Step S201, when the main switch is turned OFF (No at Step S201), the CPU 40 performs the end operation of each unit such as submerging of the image pickup optical system (Step S220) and then finishes the process.

As explained above, the image pickup device has the shading detection means for pre-emitting auxiliary light, obtaining an image thereof, evaluating it, and detecting an occurrence of shading, thereby can confirm the shading occurrence state before actual photographing. Therefore, when the device can respond to it by trimming depending on the judgment of a user, he can continue straight the photographing or he changes the zoom position and the object distance so as to prevent an occurrence of shading, sets the same photographing power, and then can photograph the object, thereby can provide an image pickup device capable of photographing in accordance with his photographing image.

Further, the device, under the photographing condition using the auxiliary light emitting means, is structured so as to detect shading of emission of light of the auxiliary light emitting means, so that useless power consumption can be prevented.

### Third Embodiment

Hereinafter, the third embodiment of the present invention will be explained.

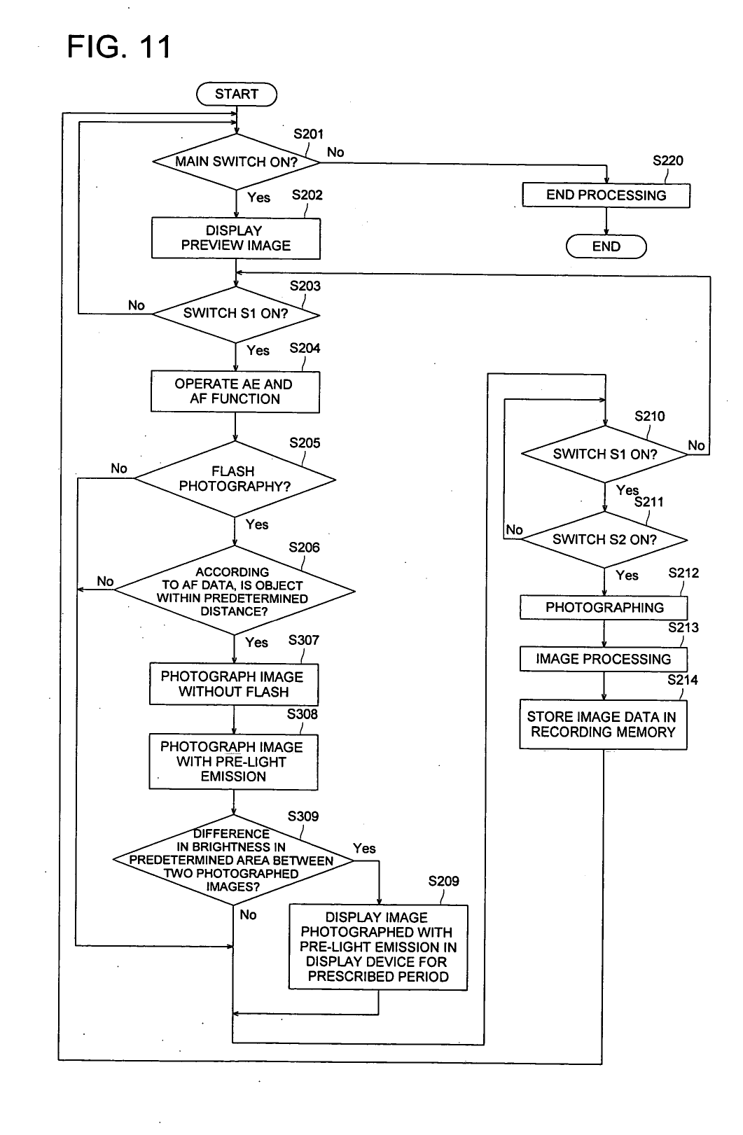

FIG. 11 is a flow chart showing an example of another schematic operation in the photographing mode of a digital camera which is an example of the image pickup device relating to the present invention. Further, similarly, the operations indicated below, on the basis of the software and constant which are stored in the ROM 20 and EEPROM 31 shown in FIG. 2, are performed by the CPU 40 controlling each unit. Further, in this embodiment, the same numerals are assigned to the same parts as those of the flow chart shown in FIG. 7, and the duplicate explanation is avoided, and only different parts will be explained.

In the drawing, Steps S201 to S206 are the same as those shown in FIG. 7. At Step S206, when the object distance is judged to be shorter than a predetermined distance (Yes at Step S206), the CPU 40 obtains an image by normal light using no flash (Step S307). Next, the CPU 40 fetches an image by pre-emitting the flash light emitting section which is an auxiliary light emitting means (Step S308). This pre-emission of light may be emission of light at a small guide number because the object distance is short.

Hereafter, the CPU 40 compares the two fetched images and judges whether there is a big difference between predetermined areas of the two images or not (Step S309).

FIGS. 12(a) and 12(b) are schematic views showing the fetched images.

In the drawings, when no shading occurs in an image by normal light using no flash and a pre-emitted image, an image as shown in FIG. 12(a) is obtained. However, when shading occurs in the pre-emitted image, an image whose peripheral part is crushed and is darkened as shown in FIG. 12(b) is obtained.

Namely, at Step S309, the CPU 40 compares the whole of the two images or a part thereof where shading is estimated to occur due to the camera layout, that is, the lower right peripheral area in this example, thereby can detect an occurrence of shading. This detection means compares two images using a flash and using no flash, so that a more-reliable shading occurrence detection means free of effect of the brightness distribution of the photographed field is obtained.

Again in FIG. 11, at Step S309, when the predetermined areas of the two compared images are different in brightness (Yes at Step S309), the CPU 40 displays the image obtained by pre-emission of light on the display unit 100 (refer to FIG. 2) for a predetermined time, for example, for about 3 to 5 seconds (Step S209). Namely, when an occurrence of shading is detected by the shading detection means, the CPU 40 displays the image on the display unit for warning. Namely, as shown in FIG. 12(b), the shaded image is displayed.

Next, the CPU 40 judges again whether the switch S1 is turned ON or not (Step S210). At the subsequent Steps S210 to S214, the same operations as those shown in FIG. 7 are performed.

Further, to fetch the image by normal light using no flash at Step S307 mentioned above, when a preview image is displayed, the preview image may be used and in this case, Step S307 can be omitted.

As explained above, the CPU 40 fetches an image using auxiliary light and an image using no auxiliary light, compares the two images, detects shading of the emitted light on the basis of the comparison results, and displays the shading state on the display unit, thereby can confirm the shading occurrence state before actual photographing. Therefore, when the device can respond to it by trimming depending on the judgment of a user, he can continue straight the photographing or he changes the zoom position and the object distance so as to prevent an occurrence of shading, sets the same photographing power, and then can photograph the object, thereby can obtain an image pickup device capable of photographing in accordance with his photographing image.

Further, the device, under the photographing condition using the auxiliary light emitting means, is structured so as to detect shading of emission of light of the auxiliary light emitting means, so that useless power consumption can be prevented.

According to the embodiment described in (2), the user can confirm the existence of an occurrence of shading of the auxiliary light before photographing by a displayed image, can continue straight the photographing while confirming the image, can change the setting so as to prevent an occurrence of shading, and can perform photographing according to his photographing image.

According to (7) mentioned above, the device, under the photographing condition using the auxiliary light emitting means, detects shading, so that useless power consumption can be prevented.

According to (8) mentioned above, more-reliable shading occurrence detection free of effect of the brightness distribution of the photographed field can be performed.

According to (9) mentioned above, the device, under the photographing condition using the auxiliary light emitting means, detects shading, so that useless power consumption can be prevented.

According to (10) mentioned above, the device, since the comparison area is restricted, can judge in a short time, thus a smooth photographing operation can be performed.

According to (11) mentioned above, useless power consumption can be prevented and the user can confirm the existence of an occurrence of shading of the auxiliary light before photographing by a displayed image and can perform photographing according to his photographing image by a smooth operation.

### Fourth Embodiment

Hereinafter, the fourth embodiment of the present invention will be explained.

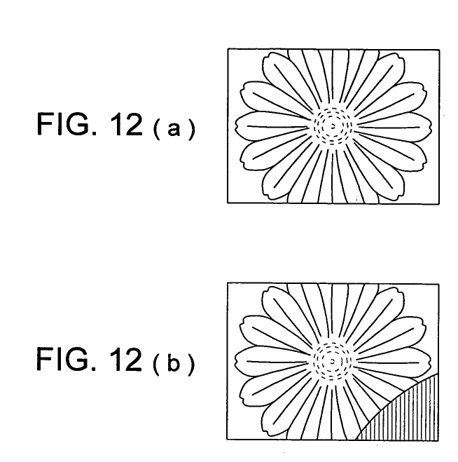

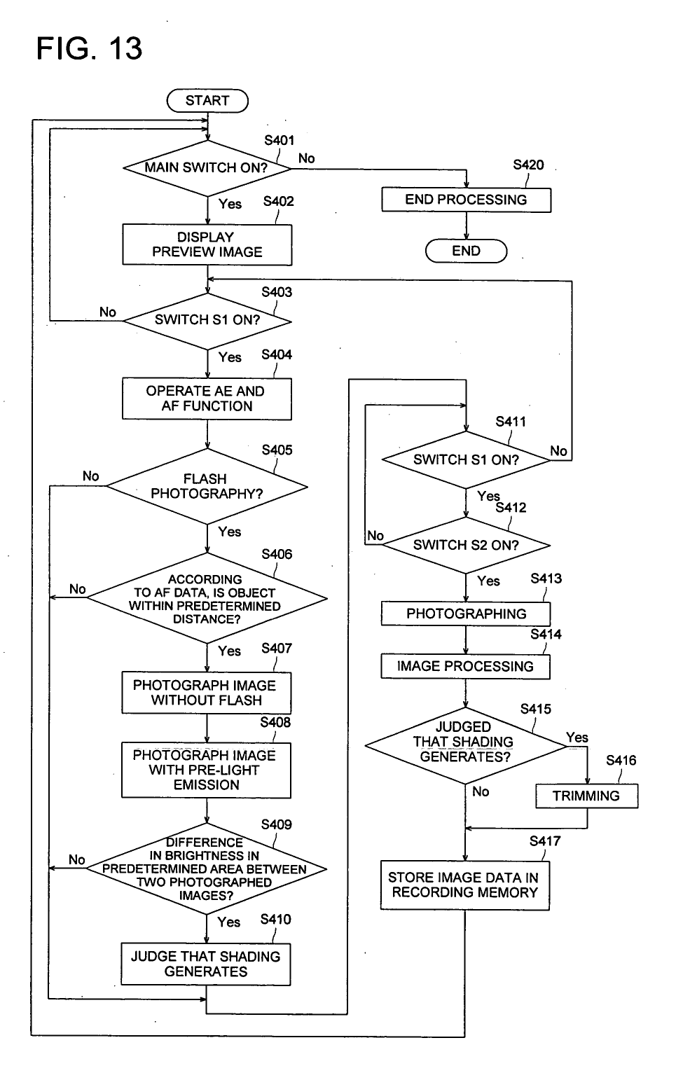

FIG. 13 is a flow chart showing the schematic operation in the photographing mode of a digital camera which is an example of the image pickup device relating to the present invention. Further, the operations indicated below, on the basis of the software and constant which are stored in the ROM 20 and EEPROM 31 shown in FIG. 2, are performed by the CPU 40 controlling each unit. Hereinafter, the operations will be explained by referring to FIG. 13.

In FIG. 13, firstly, the CPU 40 judges whether the main switch is turned ON (Step S401). When the main switch is turned ON (Yes at Step S401), the CPU 40 displays a preview image (Step S402). The preview image, as described above, is displayed on the image display section 100 (refer to FIG. 2).

Hereafter, the CPU 40 waits for the switch S1 to be turned ON (Step S403). When the switch S1 is not turned ON (No at Step S403), the process enters the loop of S401 to S403 and unless the main switch is turned OFF at Step S401, the preview image is displayed continuously.

When the switch S1 is turned ON (Yes at Step S403), the CPU 40 performs the operations of the AE and AF functions (Step S404). The operations of the AE and AF functions, as mentioned above, determine the exposure conditions of an aperture value and a shutter speed during photographing and necessity of flash light emission and determine an optimal focusing lens position by moving the focusing lens little by little, generating image data from pixel data obtained respectively, and evaluating on the basis of this image data.

After the operations of the AE and AF functions are finished, the CPU 40 judges whether photographing using a flash which is auxiliary light is to be performed or not, that is, whether a low brightness mode requiring flash light emission is to be used or a mode for forcibly emitting a flash is to be used (Step S405). The judgment is carried out from the AE function operation performed at Step S404 and flash mode setting results. When emission of a flash which is auxiliary light is necessary (Yes at Step S405), the CPU 40 judges from the AF function operation performed at Step S404 whether the object is within a predetermined distance or not (Step S406).

When the object distance is judged to be shorter than the predetermined distance (Yes at Step S406), the CPU 40 fetches an image by normal light using no flash (Step S407). Next, the CPU 40 fetches an image obtained by pre-emitting the flash light emitting section which is an auxiliary light emitting means (Step S408). This pre-emission of light may be emission of light at a small guide number because the object distance is short.

Hereafter, the CPU 40 (refer to FIG. 2) compares the two obtained images and judges whether there is a big difference between predetermined areas of the two images or not (Step S409).

In the graph shown in FIG. 8, that is, in the table, for example, when the zoom position of the image pickup optical system is M1 and the object distance is 0.125 m, the combination of the two exists in the area K, so that the CPU 40 judges that the distance is within the predetermined distance and fetches the image obtained by pre-emitting normal light and a flush at this time. On the other hand, for example, when the zoom position of the image pickup optical system is M5 and the object distance is 0.1 m, the combination of the two exists in the area N, so that the CPU 40 judges that the distance is larger than the predetermined distance.

Namely, fetching of an image by pre-emission of light is performed at the time of short distance photographing when flash light emission is a photographing condition. By doing this, useless power consumption can be prevented.

FIGS. 14(a) and 14(b) are schematic views showing the fetched image.

In the drawings, when no shading occurs in an image by normal light using no flash and a pre-emitted image, an image as shown in FIG. 14(a) is obtained. However, when shading occurs in the pre-emitted image, an image whose peripheral part is crushed and is darkened as shown in FIG. 14(b) is obtained.

Namely, at Step S409, the CPU 40 compares the whole of the two images or a part thereof where shading is estimated to occur due to the camera layout, that is, the lower right peripheral area in this example, thereby can detect an occurrence of shading. This detection means compares two images using a flash and using no flash, so that a more-reliable shading occurrence detection means free of effect of the brightness distribution of the photographed field is obtained.

Again in FIG. 13, at Step S409, when the CPU 40 compares the predetermined areas of the two images and the image obtained by pre-emission of light is darkened (Yes at Step S409), the CPU 40 judges that shading occurs (Step S410).

Further, when it is judged at Step S405 that no flash photographing is performed (No at Step S405) and when it is judged at Step S406 that the object distance is larger (the area indicated by N in FIG. 8) than a predetermined value (No at Step S406), the process jumps to Step S411. Further, also when it is judged at Step S409 that there is no difference between the predetermined areas of the two images to be compared (Step S409), the CPU 40 jumps to Step S411. Namely, in such a case, fetching of the image by normal light and the pre-emitted image and shading occurrence detection for comparing the images are not performed.

Next, the CPU 40 judges again at Step S411 whether the switch S1 is turned ON or not. When the switch S1 is turned OFF (No at Step S411), the CPU 40 clears the exposure conditions stored by the AE and AF operations and the data of the best focusing lens position and returns to Step S403.

When the switch S1 is kept ON continuously (Yes at Step S411), the CPU 40 waits for the switch S2 to be turned ON (Step S412). When the switch S2 is turned ON (Yes at Step S412), the CPU 40 performs the photographing process (Step S413). The photographing process is performed at the focus lens position determined at Step S404 and under the exposure conditions and the photographed image is fetched. Hereafter, the photographed pixel data is subject to the image process (Step S414) and image data is obtained.

Hereafter, the CPU 40 judges whether shading is judged to occur or not (Step S415). The reason is to confirm whether shading is determined to occur or not at Step S410. The CPU 40, when shading is judged to occur (Yes at Step S415), trims only the part where no shading occurs from the photographed image data (Step S416). Namely, the part where shading occurs is deleted.

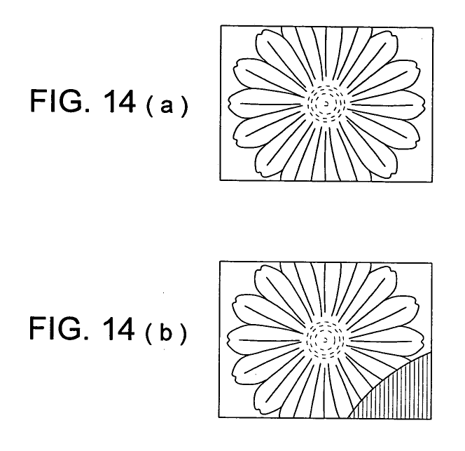

FIGS. 15(a) and 15(b) are schematic views when the part where no shading occurs is trimmed from the photographed image. FIG. 15(a) shows the photographed image and FIG. 15(b) shows the image after trimming. As shown in FIG. 15(b), the image is trimmed so as to delete the dark part D due to shading.

Again in FIG. 13, the image trimmed at Step S416 is stored in the memory card which is a recording memory (Step S417). On the other hand, when it is judged that no shading occurs (No at Step S415), the image is stored straight in the memory card which is a recording memory (Step S417).

Then, the photographing of one sheet of image is finished and the process is returned to Step S401.

On the other hand, at Step S401, when the main switch is turned OFF (No at Step S401), the CPU 40 performs the end operation of each unit such as submerging of the image pickup optical system (Step S420) in the main body of the camera and then finishes the process.

As explained above, the device is structured so as to, when an image wherein shading of auxiliary light occurs is obtained, trim the photographed image and store the trimmed image in the memory card which is a storage means, so that even a user who is not well aware of devices such as the image pickup device and a personal computer and operations thereof can photograph and record as an image free of shading.

Further, to fetch an image by normal light using no flash at Step S407 mentioned above, a preview image may be used and in this case, Step S407 can be omitted.

Further, at Steps S405 to S410, the shading detection means for detecting an occurrence of shading of auxiliary light is structured so as to detect an occurrence of shading beforehand. However, it is not essential and a constitution of confirming whether shading occurs or not from pixel data after the photographing process at Step S413 or from data after the image process at Step S414 and as a result, judging whether to perform the trimming process or not may be acceptable.

### Fifth Embodiment

Hereinafter, the fifth embodiment of the present invention will be explained.

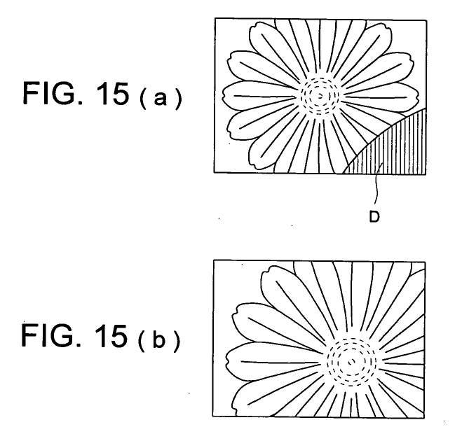

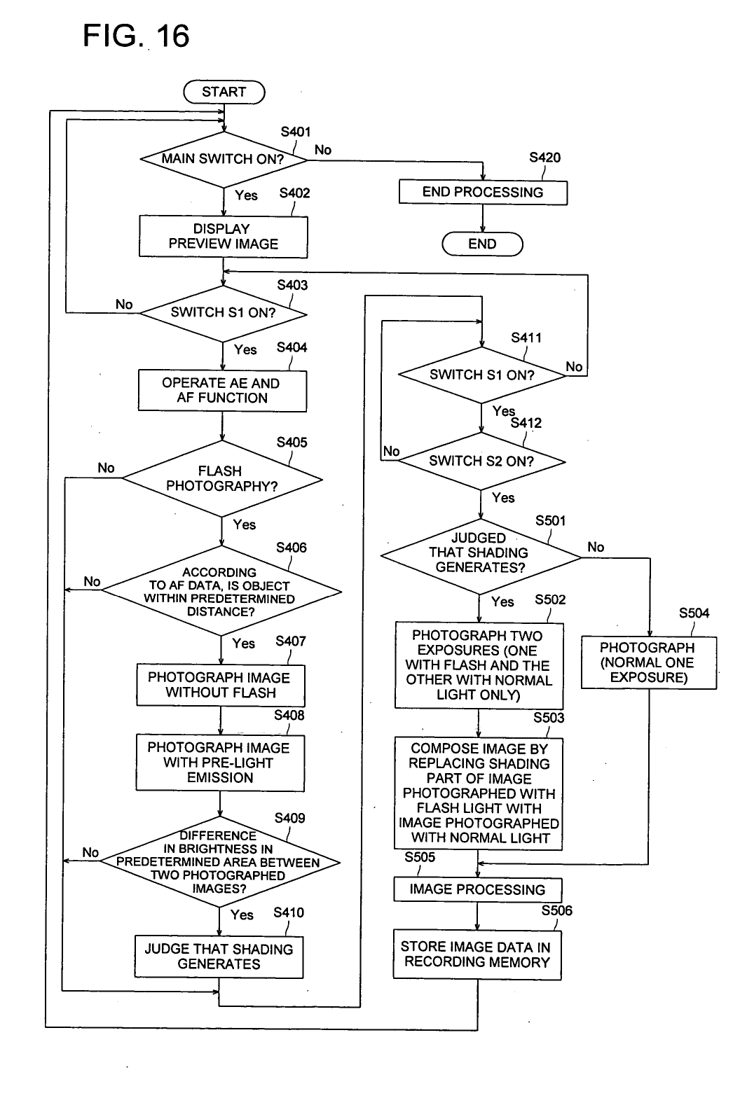

FIG. 16 is a flow chart showing an example of still another schematic operation in the photographing mode of a digital camera which is an example of the image pickup device relating to the present invention. Further, similarly, the operations indicated below, on the basis of the software and constant which are stored in the ROM 20 and EEPROM 31 shown in FIG. 2, are performed by the CPU 40 controlling each unit. Further, in this embodiment, the same numerals are assigned to the same parts as those of the flow chart shown in FIG. 13, and the duplicate explanation is avoided, and only different parts will be explained.

In FIG. 16, Steps S401 to S412 are the same as those shown in FIG. 13. At Step S412, when the switch S2 is turned ON (Yes at Step S412), the CPU 40 judges whether shading is judged to occur or not (Step S501). The reason is to confirm whether shading is determined to occur or not at Step S410.

When it is determined that shading occurs (Yes at Step S501), the CPU 40 performs the photographing process (Step S502). The photographing process at Step S502 performs photographing using flash light which is auxiliary light and photographing using normal light using no flash light to obtain pixel data of two images. Then, the CPU 40 uses the pixel data of the two images, replaces the part of the pixel data obtained using flash light, where shading occurs, with the pixel data obtained by normal light, and composes it to the pixel data of the image free of shading (Step S503).

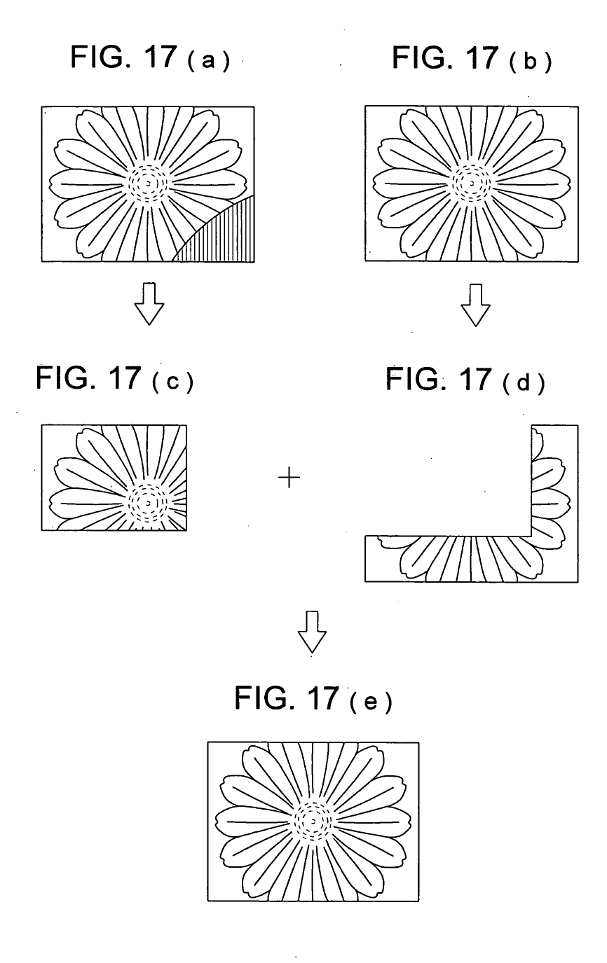

FIGS. 17(a) to 17(e) are conceptual diagrams showing an example of image composition. In the drawing, the images obtained at Step S502 mentioned above are the two images such as the image, shown in FIG. 17(a), obtained using flash light where shading occurs and the image, shown in FIG. 17(b), obtained by normal light.

From the image shown in FIG. 17(a) where shading occurs, as shown in FIG. 17(c), the part not shaded is separated. On the other hand, from the image, shown in FIG. 17(b), obtained by normal light, as shown in FIG. 17(d), the image equivalent to the part deleted by trimming is separated. The images shown in FIGS. 17(c) and 17(d) are composed to one sheet of image shown in FIG. 17(e).

Again in FIG. 16, the pixel data of the composed image free of shading is subject to the image process to obtain image data (Step S505) and it is stored in the memory card which is a recording memory (Step S506).

On the other hand, when it is determined at Step S501 that no shading occurs (No at Step S501), under the exposure conditions, determined at the time of the AE function operation at Step S404, of use or no use of a flash during photographing and an aperture value and a shutter speed, the general photographing process of one sheet is performed (Step S504), thereafter the image process is similarly performed at Step S505, and the image is stored in the memory card which is a recording memory at Step S506.

Then, the photographing of one sheet of image is finished and the process is returned to Step S401.

On the other hand, at Step S401, when the main switch is turned OFF (No at Step S401), the CPU 40 performs the end operation of each unit such as submerging of the image pickup optical system (Step S420) and then finishes the process.

Further, on the basis of the graph shown in FIG. 8, an occurrence of shading is detected, and when photographing is to be performed at that time, photographing using flash light emission and photographing using normal light are performed continuously, and from the image obtained using the flash light where shading occurs, the shaded part is separated. On the other hand, the image obtained by photographing by normal light equivalent to the separated part is separated. These images may be composed to one sheet of image.

As explained above, according to the embodiments described in (3) and (12) to (15), the device is structured so as to, when an image wherein shading of auxiliary light occurs is obtained, compose an image obtained by using auxiliary light and an image obtained by using no auxiliary light to one sheet of image free of shading and record the composed image in the memory card which is a recording means, so that even a user who is not well aware of devices such as the image pickup device and a personal computer and operations thereof can photograph and record as an image free of shading.

Furthermore, as explained above, the device may be structured so as to select any of the shading estimation mode, shading warning mode, and image composition mode.

1. An image pickup apparatus comprising:
(a) an image pickup element for photoelectrically converting a light from an object;
(b) an image pickup optical system for introducing the light from the object into the image pickup element;
(c) an auxiliary light emitting device for emitting an auxiliary light to the object;
(d) a display device for displaying an image;
(e) a shading estimation device for estimating an occurrence of a shading of the auxiliary light caused by a part of the image pickup optical system,
wherein the display device displays a state of the shading thereon on the basis of an estimated result by the shading estimation device.

2. The image pickup apparatus of claim 1, wherein the shading estimation device estimates the shading on the basis of an object distance in the vicinity of a position at which the shading is generated on an image plane to be photographed.

3. The image pickup apparatus of claim 1, wherein the state of the shading is displayed to be overlapped with a preview image.

4. The image pickup apparatus of claim 1, further comprising:
a memory device for storing image data of an image which has been photographed; and
a releasing device capable of discriminating between a half-depressed state and a full-depressed state,
wherein the display device displays the state of the shading in state where the releasing device is half-depressed, the object is photographed in state where the releasing device is full-depressed, and the memory device stores therein image data obtained by photographing the object using the auxiliary light emitting device.

5. An image pickup apparatus comprising:
(a) an image pickup element for photoelectrically converting a light from an object;
(b) an image pickup optical system for introducing the light from the object into the image pickup element;
(c) an auxiliary light emitting device for emitting an auxiliary light to the object;
(d) a display device for displaying an image;
(e) a shading detection device for detecting an occurrence of a shading of the auxiliary light caused by a part of the image pickup optical system,
wherein the display device displays thereon an image in which the shading has been detected when the shading detection device detects the shading.

6. The image pickup apparatus of claim 5, wherein when an image is obtained using the auxiliary light emitting device, the shading detection device detects the shading of a light emitted from the auxiliary light emitting device according to brightness at a predetermined position of the obtained image.

7. The image pickup apparatus of claim 5, wherein a first image of the object is obtained using the auxiliary light emitting device, and a second image of the object is obtained without using the auxiliary light emitting device, and the shading detection device detects the shading of the auxiliary light according to a comparison result between the first and second images.

8. The image pickup apparatus of claim 7, wherein the first and second images are obtained when the object requires to be photographed under the condition that the auxiliary light emitting device is used.

9. The image pickup apparatus of claim 7, wherein predetermined areas of the first and second images are compared with each other, respectively.

10. The image pickup apparatus of claim 5, further comprising:
a memory device for storing image data of an image which has been photographed; and
a releasing device capable of discriminating between a half-depressed state and a full-depressed state,
wherein shading detection device detects in state where the releasing device is half-depressed, the object is photographed in state where the releasing device is full-depressed, and the memory device stores therein image data obtained by photographing the object using the auxiliary light emitting device.

11. An image pickup apparatus comprising:
(a) an image pickup element for photoelectrically converting a light from an object;
(b) an image pickup optical system for introducing the light from the object into the image pickup element; and
(c) an auxiliary light emitting device for emitting an auxiliary light to the object;
wherein when an image in which a shading of the auxiliary light caused by a part of the image pickup optical system is generated, is obtained, a predetermined processing is conducted on the image.

12. The image pickup apparatus of claim 11, further comprising a shading detection device for detecting an occurrence of a shading of the auxiliary light,
wherein the predetermined processing is conducted when the shading detection device detects the shading.

13. The image pickup apparatus of claim 11, wherein the predetermined processing is a trimming a part of the image in which the shading is not generated.

14. The image pickup apparatus of claim 11, wherein the predetermined processing is composition processing of an image using the auxiliary light and an image without using auxiliary light.

15. The image pickup apparatus of claim 11, further comprising a memory device for storing an image which has been photographed, wherein the memory device stores the photographed image after the predetermined processing has been conducted thereon.
